(19) United States
(12) Patent Application Publication
(10) Pub. No.: US 2015/0170294 A1
(43) Pub. Date: Jun. 18, 2015

(54) METHOD AND APPARATUS FOR SCHEDULING MULTIPLE SOCIAL MEDIA POSTS TO MAXIMIZE ENGAGEMENT AND ON-SITE ACTIVITY

(71) Applicant: ADOBE SYSTEMS INCORPORATED, San Jose, CA (US)

(72) Inventors: Pawan Goyal, Noida (IN); Mohit Garg, New Delhi (IN); Ankur Jain, Noida (IN); Vivek Kumar, Noida (IN); Anandhavelu Natarajan, Bengaluru (IN)

(73) Assignee: ADOBE SYSTEMS INCORPORATED, San Jose, CA (US)

(21) Appl. No.: 14/109,215

(22) Filed: Dec. 17, 2013

(51) Int. Cl. G06Q 50/00; G06Q 30/02

(52) U.S. Cl. CPC G06Q 50/01; G06Q 30/0264

(57) ABSTRACT

A computer implemented method and apparatus for scheduling multiple social media posts to maximize engagement and on-site activity. The method comprises accessing a plurality of posts and scheduling information for the plurality of posts, wherein the scheduling information comprises a time period during which the plurality of posts is to be scheduled for posting on an online social media site; predicting a response to each post at a plurality of times that fall within the time period; and scheduling, based on the predicted responses to each post, a time to post each post of the plurality of posts, wherein scheduling maximizes the predicted response to each post.

### BACKGROUND

1. Field of the Invention

Embodiments of the present invention generally relate to social media and, more particularly, to a method and apparatus for scheduling multiple social media posts to maximize engagement and on-site activity.

2. Description of the Related Art

Social media marketing programs often center on efforts to create content that attracts attention and encourages readers to share the content with their social networks. There are typically two types of interactions with respect to social media content, namely engagement and on-site activity. Engagement refers to a number of reaches, likes, comments, shares, and/or the like that posted content receives. On-site activity refers to a number of clicks, visits, downloads, revenue generated, and/or the like from posted content. A very important aspect of social media marketing is to present content to users at key times that maximize engagement and on-site activity. It may not be difficult to determine a time to post a single post such that it will be expected to result in maximum engagement and on-site activity. However, when a set of posts needs to be posted over a given time period, manual intervention and educated guesswork are required for dynamically scheduling the set of posts because the posting of a first post influences the engagement and on-site activity of a second post. Such manual intervention and guesswork often lead to wasted time and lost marketing opportunities.

Therefore, there is a need for a method and apparatus for scheduling multiple social media posts to maximize engagement and on-site activity.

### SUMMARY

A method for scheduling multiple social media posts to maximize engagement and on-site activity is described. The method accesses a plurality of posts and scheduling information for the plurality of posts. The scheduling information includes a time period during which the plurality of posts is to be scheduled for posting on an online social media site. A response is predicted for each post at a plurality of times that fall within the time period. A time is scheduled for posting each post in the plurality of posts, wherein the scheduled time improves the predicted response to the plurality of posts.

In another embodiment, an apparatus for scheduling multiple social media posts to maximize engagement and on-site activity is described. The apparatus includes a prediction module and a scheduling module. The prediction module accesses a plurality of posts and scheduling information for the plurality of posts, wherein the scheduling information comprises a time period during which the plurality of posts is to be scheduled for posting on an online social media site, and predicting a response to each post at a plurality of dates and times that fall within the time period. A scheduling module schedules, based on the predicted responses to each post, a time to post each post of the plurality of posts, wherein scheduling improves the predicted response to the plurality of posts.

In another embodiment, a computer readable medium for storing computer instructions that, when executed by at least one processor causes the at least one processor to perform a method for scheduling multiple social media posts to maximize engagement and on-site activity is described. The method accesses a plurality of posts and scheduling information for the plurality of posts. The scheduling information includes a time period during which the plurality of posts is to be scheduled for posting on an online social media site. A response is predicted for each post at a plurality of times that fall within the time period. A time is scheduled for posting each post in the plurality of posts, wherein the scheduled time improves the predicted response to the plurality of posts.

The Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of an apparatus for scheduling multiple social media posts to maximize engagement and on-site activity, according to one or more embodiments;

FIG. 2 depicts a flow diagram of a method for scheduling multiple social media posts to maximize engagement and on-site activity as performed by the prediction module and scheduling module of FIG. 1, according to one or more embodiments;

FIG. 3 depicts a flow diagram of a method for generating a prediction matrix as performed by the prediction module of FIG. 1, according to one or more embodiments; and

FIG. 4 depicts an illustration of how posts are scheduled to improve engagement and on-site activity for a plurality of posts in a given timeframe, according to one or more embodiments.

While the method and apparatus is described herein by way of example for several embodiments and illustrative drawings, those skilled in the art will recognize that the method and apparatus for scheduling multiple social media posts to maximize engagement and on-site activity is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and apparatus for scheduling multiple social media posts to maximize engagement and on-site activity defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

Embodiments of the present invention include a method and apparatus for scheduling multiple social media posts to maximize engagement and on-site activity. A plurality of posts are received from an entity, for example a marketer. A time period within which the posts need to be posted is also received from the marketer. The posts are then processed to predict engagement and on-site activity for the posts for a plurality of times within the time period. The processing includes extracting features, such as keywords, style, concepts, and the like, from each post in the plurality of posts. The features in addition to a target audience are provided to a prediction engine that predicts engagement and on-site activity for each post at a plurality of times. A prediction matrix is created that includes a weighted sum of the predicted engagement and on-site activity for each post in each time of the plurality of times.

The prediction matrix is used to determine an improved weighted aggregate predicted response for all of the posts. More specifically, a schedule is generated that provides a maximum number of responses for all posts as a whole during a specific time period.

Advantageously, the present invention may be embodied as a computer software plug-in or application extension to social marketing software, such as ADOBE® Social Content Calendar. Alternatively, the present invention may be hosted as a service integrated with any third party Content Publishing and Scheduling solution, or delivered to an end user via an App or a web browser. The present invention allows a social marketing team or marketing agency to optimize the scheduling of a plurality of marketing content on social media.

As used herein a social media site is an online social networking community website, such as FACEBOOK® or TWITTER® that enables users to share content. A post is any kind of digital content that is shared on a social media site, for example, text messages, images, universal resource locators (URLs), and the like. Furthermore, a post or a plurality of posts may comprise marketing content.

Various embodiments of a method and apparatus for scheduling multiple social media posts to maximize engagement and on-site activity are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description that follow are presented in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

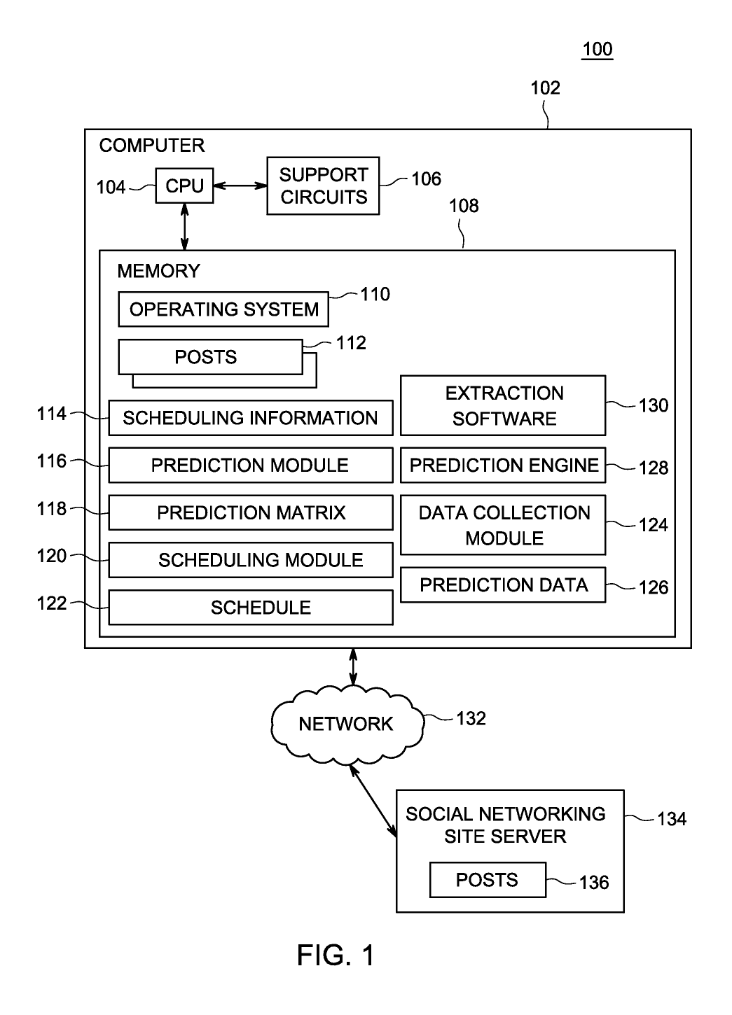

FIG. 1 is a block diagram of a system 100 for scheduling multiple social media posts to maximize engagement and on-site activity, according to one or more embodiments. The system 100 includes a marketing server 102, a social networking site (SNS) server 134, communicatively connected via a network 132. The marketing server 102 is a computing device. Examples of marketing server 102 include, but are not limited to desktop computers, laptops, tablet computers, and the like. The server 102 includes a Central Processing Unit (CPU) 104, support circuits 106, and a memory 108. The CPU 104 may include one or more commercially available microprocessors or microcontrollers that facilitate data processing and storage. The various support circuits 106 facilitate the operation of the CPU 104 and include one or more clock circuits, power supplies, cache, input/output circuits, and the like. The memory 108 includes at least one of Read Only Memory (ROM), Random Access Memory (RAM), disk drive storage, optical storage, removable storage and/or the like.

The memory 108 includes an operating system 110, a plurality of posts 112, scheduling information 114, a prediction module 116, a prediction matrix 118, a scheduling module 120, a schedule 122, a data collection module 124, prediction data 126, a prediction engine 128, and feature extraction software 130. The scheduling information 114 includes at least a time period over which the plurality of posts 112 are to be scheduled, and one or more of a minimum time duration between the posting of two posts in the plurality of posts 112, a target audience for the plurality of posts 112, engagement parameters, on-site activity parameters, and/or other information that may be identified to take into consideration during scheduling the plurality of posts 112. The operating system 110 may include various commercially known operating systems.

The social networking site (SNS) server 134 is a type of computing device (e.g., a laptop, a desktop, a Personal Digital Assistant (PDA) and/or the like). The SNS server 134 is a server for a social networking site, such as Twitter, Facebook, Weibo, QQ, Renren, and the like, where posts may be shared and responded to by users of the SNS. The SNS server 134 is representative of one or more SNS servers 134 from which the data collection module 124 retrieves posts 136 and associated responses and store them as prediction data 126.

The network 132 comprises a communication system that connects computers by wire, cable, fiber optic and/or wireless link facilitated by various types of well-known network elements, such as hubs, switches, routers, and the like. The network 132 may employ various well-known protocols to communicate information amongst the network resources. For example, the network may be a part of the Internet or Intranet using various communications infrastructure, such as Ethernet, Wi-Fi, Wi-Max, General Packet Radio Service (GPRS), and the like.

The prediction module 116 accesses the plurality of posts 112 and the scheduling information 114. The prediction module 116 divides the time period that is provided in the scheduling information 114 into specific dates and times for which predictions are made. For example, if the time period is one week, Monday through Sunday, the specific times may be Monday 8 am, Monday 2 pm, Monday 10 pm, Tuesday 8 am, Tuesday 2 pm, Tuesday 10 pm, etc. The prediction module 116 extracts features from each post in the plurality of posts 112. Features are based on content, for example, style, keywords, concepts used, and the like. The prediction module 116 may use feature extraction software 130. The prediction module 116 also identifies the target audience specified in the scheduling information 114. The target audience may be any demographic, for example, college students aged 18-22.

The prediction module 116 predicts the engagement and on-site activity for each post in the plurality of posts 112 at each specific time for which predictions are made using prediction engine 128. The prediction engine 128 uses prediction data 126 collected by the data collection module 124 from the SNS server 134. The predictions are based on a plurality of parameters including, but not limited to, the performance of past posts on the same social media channel, other industry channels, and the like, current trending topics for the target audience as measured by various sources, online behavior of the target audience for a particular post, and feature overlaps with posts that have already been scheduled. The predictions are stored in prediction matrix 118. The scheduling module 120 accesses the prediction matrix 118 and the scheduling information 114 to determine the overall time period for posting the plurality of posts 112 and a minimum duration of time between posts. The scheduling module 120 generates a schedule 122 that optimizes the predicted engagement and on-site activity for each post based on the scheduling of the plurality of posts 112.

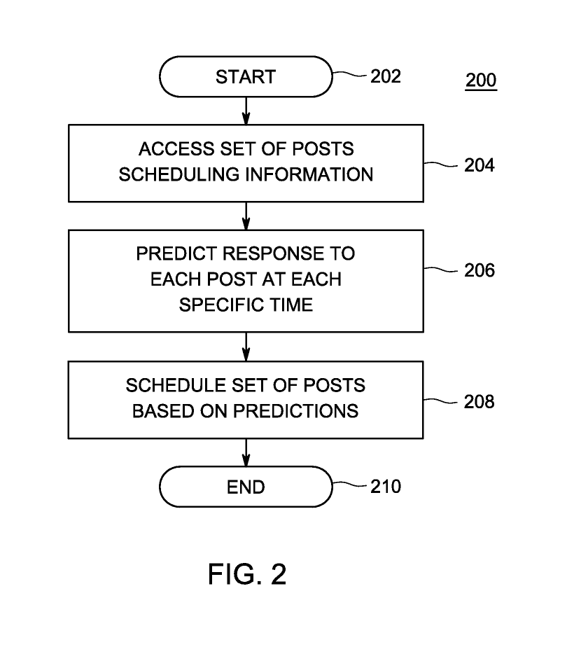

FIG. 2 depicts a flow diagram of a method 200 for scheduling multiple social media posts to maximize engagement and on-site activity as performed by the prediction module 116 and the scheduling module 120 of FIG. 1, according to one or more embodiments. The method 200 predicts engagement and on-site activity for each post in a plurality of post, at each specified time in a given time period when the plurality of posts is to be scheduled. The method 200 then optimizes a scheduling of the plurality of posts based on the predictions. The method 200 starts at step 202 and proceeds to step 204.

At step 204, the method 200 accesses a plurality of posts and scheduling information for the posts received from a marketer. The marketer provides the plurality of posts and a time period in which the marketer wants to trigger the posts. The posts include media content and are typically directed to a target audience. For example, a post may read, “Winter is coming! Create your own Game of Thrones artwork with these tips by Photoshop Tutorials: http://bit.ly/1aCpta5.” The scheduling information includes at least a time period over which the plurality of posts is to be scheduled. The scheduling information may also include a minimum time duration between the posting of two posts in the plurality of posts, a target audience for the plurality of posts, engagement parameters, on-site activity parameters, and/or other information that may be identified to take into consideration during scheduling of the plurality of posts.

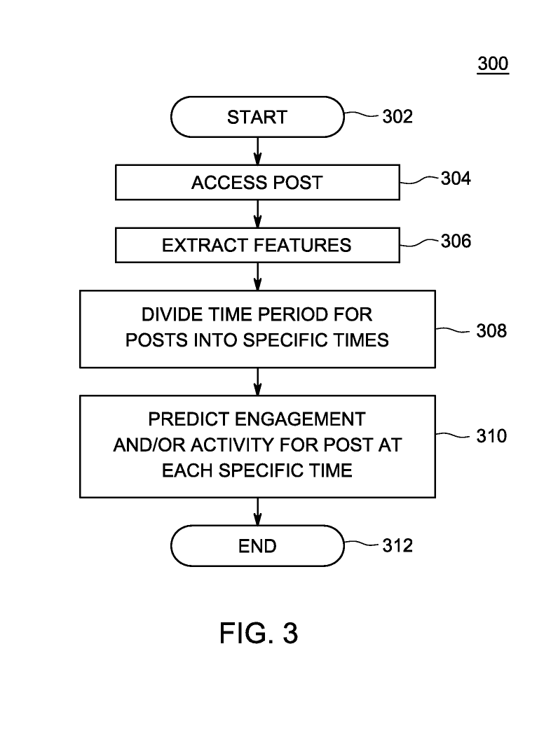

The method 200 proceeds to step 206, where the method 200 uses a prediction engine to predict engagement metrics that the post would receive if it were posted at a given time, as described in further detail with respect to FIG. 3 below. The result of the predictions is a prediction matrix that includes each post and a weighted sum of a predicted engagement and on-site activity level for each post at each specified time.

The method 200 proceeds to step 208, where the method 200 schedules the plurality of posts based on the predictions. The method 200 accesses the prediction matrix. The prediction matrix includes values Eᵢ(tᵢ) representing the engagement level for each post i at time tᵢ.and Sᵢ(tᵢ) representing the on-site activity level for each post i at time tᵢ,

The method 200 uses the values in the prediction matrix to determine the optimal time (tᵢ) to schedule each post. The method 200 uses Equation 1 to calculate a maximum engagement/on-site activity level for each post:

maxₜ_{ᵢ}_{εT,|t}_{ᵢ}₋ₜ_{ⱼ}_{|≧D}{Σᵢ₋₁^{N}(A·Eᵢ(tᵢ)+B·Sᵢ(tᵢ)} Eq. 1

where
A represents a weight to the engagement level,
B represents a weight to the on-site activity level,
N represents a number of posts in the plurality of posts,
Eᵢ(tᵢ) represents the engagement level for post i at time tᵢ,
Sᵢ(tᵢ) represents the on-site activity level for post i at time tᵢ,
T represents the time period within which the posts are to be scheduled,
tᵢ represents a specific time for which engagement and on-site activity is predicted for post i, and
D represents the minimum time duration between two posts.

The weights A and B are set based on the level of importance of each of the engagement and on-site activity to a marketer. For example, if the marketer only wants to consider engagement levels, the weight for engagement, A is set to 1 and the weight for on-site activity, B is set to 0. If the marketer wants to consider the engagement and on-site activity equally, A is set to 0.50 and the weight for on-site activity, B is set to 0.50.

The equation determines the time (tᵢ) when predicted engagement and on-site activity are maximized for the time period based on the scheduling of the other N−1 posts.

Alternatively, schedule optimization may be performed using any applicable optimization algorithm, such as the Assignment Problem as known in linear programming, using the Hungarian method to maximize the predicted engagement and on-site activity.

Hence, a marketer is provided with the optimal schedule for multiple posts to be posted during a specified time period. The schedule provides a time for each post to be posted to a social media site such that the post is predicted to yield an aggregate optimization of engagement and on-site activity for the plurality of posts. For example, as Table 1 illustrates, Post 3 should be scheduled for November 12 at 10 am, Post 1 should be scheduled for November 13 at 10 am, and Post 2 should be scheduled for November 14 at 10 am.

TABLE 1

| | Nov. 12, 10 am | Nov. 13, 10 am | Nov. 14, 10 am |
|---|---|---|---|
| Post 1 | 120 | 140 | 160 |
| Post 2 | 150 | 180 | 300 |
| Post 3 | 100 | 70 | 40 |

The prediction optimizes a weighted aggregate predicted response. In the current example, the weighted aggregate response=100+140+300=540. Although Post 1 may have received a greater response on November 14 at 10 am than November 13 at 10 am, when considering the plurality of posts as a whole, the weighted aggregate response is received when Post 1 is posted on November 13 at 10 am. The method 200 proceeds to step 210 and ends.

FIG. 3 is a flowchart of a method 300 for generating a prediction matrix, as performed by the prediction module 116 of FIG. 1, according to one or more embodiments. The method 300 predicts a response to each post in the plurality of posts for a plurality of times within the time period over which the plurality of posts are to be scheduled. It is noted that the steps of method 300 may take place in an order different from that shown, for example, step 308 may take place before step 306 without any effect on step 310. The method 300 starts at step 302 and proceeds to step 304

At step 304, the method 300 accesses a post in the plurality of posts. The post includes content. The content of the post influences the response to the post, specifically, the engagement and on-site activity. The post may also include a target audience. The target audience influences when a post should be posted to a social media site. For example, a post that is targeted to college students aged 18-22 is likely to get a greater engagement and on-site activity levels at 10 pm on a weeknight, when many college students are at their computers, than it will at 8 am on a Saturday, when many college students are sleeping.

The method 300 proceeds to step 306, where the method 300 extracts features from the post. The method 300 may use any extraction software known in the art. The features may include keywords, a style of the post, the concepts used in the post, and the like. For example, a sample post may read, “Winter is coming! Create your own Game of Thrones artwork with these tips by Photoshop Tutorials: http://bit.ly/1aCpta5.” The post may have an attached image and be targeted people aged 15-30 years in the USA. In this post, some features may be, the attached image, winter, “Game of Thrones”, and Photoshop.

The method 300 proceeds to step 308, where the method 300 determines specific times for which to predict a response to the post. The time period within which the plurality of posts is to be scheduled is used to determine specific times. In some embodiments, the specific times are predefined times for scheduling, such as 8 am, 2 pm, and 10 pm on weekdays and 10 am, 4 pm, and 8 pm on weekends. In some embodiments, the time period is divided into evenly spaced intervals within the time period. In either case, the number of specific times must be greater than or equal to the number of posts in the plurality of posts because no two posts are posted at the same time. In addition, a minimum time duration between posts may be specified in the scheduling information, which must be complied with when determining scheduling times.

The method 300 proceeds to step 310, where the method 300 predicts an engagement level and an on-site activity level for each post at each specific time within the time period. The method 300 provides the target audience, keywords, features, and each specific time as input to a prediction engine. The engagement level for a post and the on-site activity level for the post at time are calculated based on previous engagement and on-site activity levels taking into consideration a plurality of parameters. The plurality of parameters are limited only by the prediction engine used and may include, but are not limited to the performance of past posts on the same social media site, current trending topics for the audience as measured by various sources (e.g., TWITTER, GOOGLE search trends, and the like), online behavior of the target audience and content overlap with posts that have already been scheduled. The predictions may be performed using any prediction engine known in the art.

For example, Table 2 illustrates predictions for the exemplary post as follows:

TABLE 2

| Time | Nov. 12, 10 am | Nov. 13, 10 am | Nov. 14, 10 am |
|---|---|---|---|
| Engagement Prediction | 80 | 90 | 100 |
| On-site Activity | 40 | 50 | 60 |
| Prediction | | | |
| Weighted Sum | 120 | 140 | 160 |

Each predicted value is stored in a prediction matrix. The prediction matrix identifies each post and the engagement and on-site activity level for each specific time in the time period.

For example, Table 3 illustrates the prediction matrix for three posts as follows:

TABLE 3

| | Nov. 12, 10 am | Nov. 13, 10 am | Nov. 14, 10 am |
|---|---|---|---|
| Post 1 | 120 | 140 | 160 |
| Post 2 | 150 | 180 | 300 |
| Post 3 | 100 | 70 | 40 |

The method proceeds to step 312 and ends.

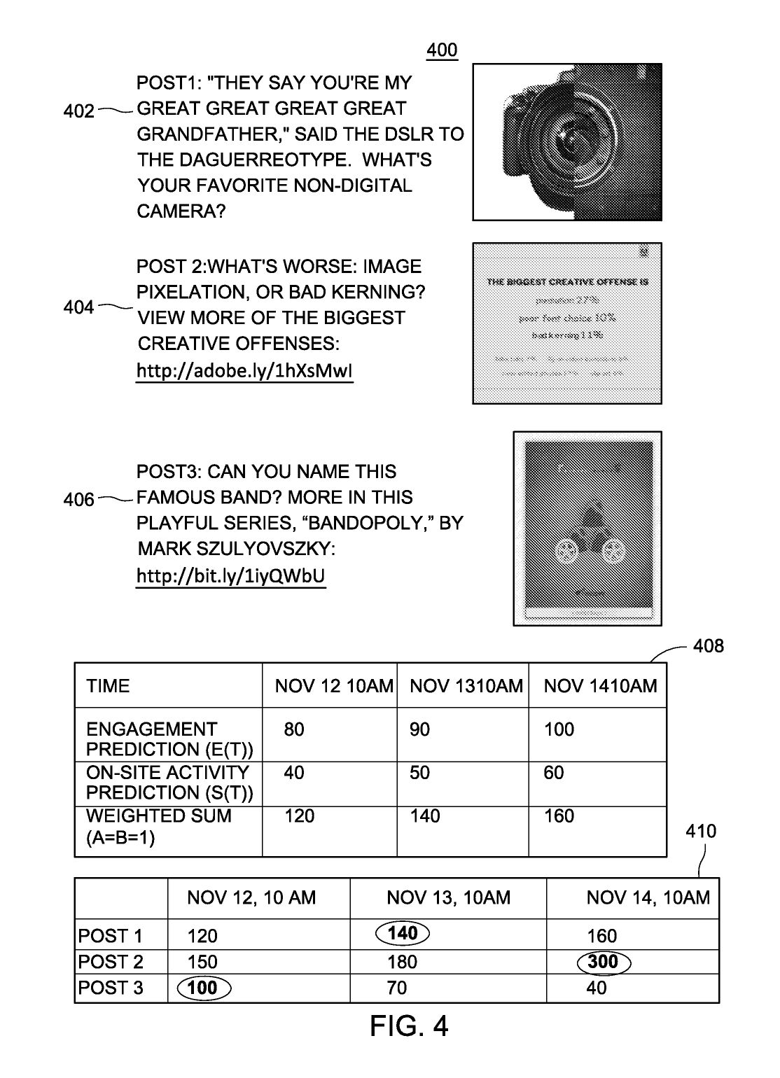

FIG. 4 depicts an illustration 400 of how posts are scheduled to improve engagement and on-site activity for a plurality of posts in a given timeframe, according to one or more embodiments. Three posts 402, 404, and 406 are provided by a marketer to be scheduled at times November 12, 10 am, November 13, 10 am and November 14, 10 am.

Post1 402 has a target audience of New York, N.Y. Post 404 has at a target audience of Global, meaning the post can be viewed by anyone. Post 406 has a target audience of USA. Features are extracted from each post, as described in step 306 above. Features for post1 402 are keywords DSLR, great great great great grandfather, Daguerreotype, and camera. In addition to keywords, other features of the post are used for prediction. Other features for post1 402 are non-human readable features and social property history. Features for post2 404 are keywords image pixilation, kerning, and creative offenses. Other features for post2 402 are non-human readable features and social property history. Features for post3 406 are keywords band, Bandopoly, and Mark Szulyovszky. Other features for post3 406 are non-human readable features.

The extracted features for each post are used as input into a prediction module to predict engagement and on-site activity for each post at each of the times provided by the marketer. Engagement is defined as a number of likes+a number of comments+a number of shares. On-site activity is defined as a number of page views.

The prediction table 408, shows the predicted engagement metrics for post1 402 for each of the times provided by the marketer. The engagement prediction and the on-site activity prediction are weighted equally. As such the weighted sum is the sum of the engagement prediction _the on-site activity prediction. A similar table is created for Post2 404 and Post3 406 for the times provided by the marketer.

Prediction matrix 410 summarizes the weighted sums of Post1 402, Post2 404, and Post3 406 at each of the provided times. Individually, Post1 402 is predicted to receive the greatest engagement and on-site activity when posted November 14 at 10 am. Similarly, Post2 404 is predicted to receive the greatest engagement and on-site activity when posted November 14 at 10 am. Post3 406 is predicted to receive the greatest engagement and on-site activity when posted November 12 at 10 am.

A marketer wants to find the optimal time for posting each of the three posts 402, 404, 406 such that the weighted aggregate sum can be maximized. In other words, the marketer wants to receive a maximum engagement and on-site activity for posting Post1, Post2 and Post2 at the three specified times. The predicted on-site activity and engagement for each post at each time are used as input to Equation 1. Using the Assignment Problem as known in linear programming, using the Hungarian method to maximize the predicted engagement and on-site activity, the maximum total on-site activity and engagement are predicted when Post1 402 is posted on November 13 at 10 am, Post2 404 is posted on November 14 at 10 am and Post3 406 is posted on November 12 at 10 am. The total weighted sum for the three posts is 140+300+100=540.

The embodiments of the present invention may be embodied as methods, apparatus, electronic devices, and/or computer program products. Accordingly, the embodiments of the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium include the following: hard disks, optical storage devices, a transmission media such as those supporting the Internet or an intranet, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java™, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer implemented method comprising:
accessing a plurality of posts and scheduling information for the plurality of posts, wherein the scheduling information comprises a time period during which the plurality of posts is to be scheduled for posting on an online social media site;
predicting a response to each post at a plurality of times that fall within the time period; and
scheduling, based on the predicted responses to each post, a time to post each post of the plurality of posts, wherein scheduling improves a weighted aggregate predicted response to the plurality of posts.

2. The method of claim 1, wherein predicting the response comprises:
dividing the time period into a number of dates and times equal to a number of posts in the plurality of posts;
extracting features from each post in the plurality of posts;
calculating an engagement level and on-site activity level for each date and time for a post based on the extracted features and the scheduling information; and
storing the prediction.

3. The method of claim 2, wherein scheduling information comprises a target audience on the online social media site and a minimum time duration between two postings.

4. The method of claim 2, wherein engagement with a post comprises at least one of reaches, likes, comments, or shares on the social media site and wherein on-site activity comprises at least one of clicks, visits, downloads, or revenue on the social media site.

5. The method of claim 1, wherein predicting is based on performance of a plurality of previous posts on the online social media site, one or more current trending topics for the target audience, on-line behavior of the target audience, and overlapping features with posts that have already been scheduled.

6. The method of claim 2, wherein features comprise at least one of a style of the post, one or more keywords in the post, or one or more concepts used in the post.

7. The method of claim 1, wherein scheduling comprises:
accessing the predictions for each post for each date and time in the time period; and
optimizing the predictions to determine the date and time for each post wherein the date and time provide the improved weighted aggregate predicted response based on the scheduling of the other posts in the plurality of posts.

8. An apparatus for scheduling multiple social media posts to maximize engagement and on-site activity comprising:
a computer having one or more processors and further comprising:
a prediction module for accessing a plurality of posts and scheduling information for the plurality of posts, wherein the scheduling information comprises a time period during which the plurality of posts is to be scheduled for posting on an online social media site, and predicting a response to each post at a plurality of dates and times that fall within the time period; and
a scheduling module for scheduling, based on the predicted responses to each post, a time to post each post of the plurality of posts, wherein scheduled time improves a weighted aggregate predicted response to the plurality of posts.

9. The apparatus of claim 8, wherein predicting the response comprises:
dividing the time period into a number of dates and times equal to a number of posts in the plurality of posts;
extracting features from each post in the plurality of posts wherein features comprise at least one of a style of the post, one or more keywords in the post, or one or more concepts used in the post;
calculating an engagement level and on-site activity level for each date and time for a post based on the extracted features and the scheduling information; and
storing the prediction.

10. The apparatus of claim 9, wherein scheduling information comprises a target audience on the online social media site and a minimum time duration between two postings.

11. The apparatus of claim 9, wherein engagement with a post comprises at least one of reaches, likes, comments, or shares on the social media site and wherein on-site activity comprises at least one of clicks, visits, downloads, or revenue on the social media site.

12. The apparatus of claim 8, wherein predicting is based on performance of a plurality of previous posts on the online social media site, one or more current trending topics for the target audience, on-line behavior of the target audience, and overlapping features with posts that have already been scheduled.

13. The apparatus of claim 8, wherein scheduling comprises:
accessing the predictions for each post for each date and time in the time period; and
optimizing the predictions to determine the date and time for each post wherein the date and time provide the improved weighted aggregate predicted response based on the scheduling of the other posts in the plurality of posts.

14. A non-transient computer readable medium for storing computer instructions that, when executed by at least one processor causes the at least one processor to perform a method for scheduling multiple social media posts to maximize engagement and on-site activity comprising:
accessing a plurality of posts and scheduling information for the plurality of posts, wherein the scheduling information comprises a time period during which the plurality of posts is to be scheduled for posting on an online social media site;
predicting a response to each post at a plurality of times that fall within the time period; and
scheduling, based on the predicted responses to each post, a time to post each post of the plurality of posts, wherein scheduling improves a weighted aggregate predicted response to the plurality of posts.

15. The computer readable medium of claim 14, wherein predicting the response comprises:
dividing the time period into a number of dates and times equal to a number of posts in the plurality of posts;
extracting features from each post in the plurality of posts;
calculating an engagement level and on-site activity level for each date and time for a post based on the extracted features and the scheduling information; and
storing the prediction.

16. The computer readable medium of claim 15, wherein scheduling information comprises a target audience on the online social media site and a minimum time duration between two postings.

17. The computer readable medium of claim 15, wherein engagement with a post comprises at least one of reaches, likes, comments, or shares on the social media site and wherein on-site activity comprises at least one of clicks, visits, downloads, or revenue on the social media site.

18. The computer readable medium of claim 14, wherein predicting is based on performance of a plurality of previous posts on the online social media site, one or more current trending topics for the target audience, on-line behavior of the target audience, and overlapping features with posts that have already been scheduled.

19. The computer readable medium of claim 15, wherein features comprise at least one of a style of the post, one or more keywords in the post, or one or more concepts used in the post.

20. The computer readable medium of claim 14, wherein scheduling comprises:
accessing the predictions for each post for each date and time in the time period; and
optimizing the predictions to determine the date and time for each post wherein the date and time provide the improved weighted aggregate predicted response based on the scheduling of the other posts in the plurality of posts.
